(19) United States
(12) Patent Application Publication
(10) Pub. No.: US 2006/0119422 A1
(43) Pub. Date: Jun. 8, 2006

(54) Semiconductor device including current control circuit of reference current source

(76) Inventors: Satoshi Sakurai, Kawasaki-shi (JP); Noriaki Dobashi, Yokohama-shi (JP)

Correspondence Address: DLA PIPER RUDNICK GRAY CARY US, LLP, 2000 UNIVERSITY AVENUE, E. PALO ALTO, CA, 94303-2248, US

(21) Appl. No.: 11/261,985

(22) Filed: Oct. 28, 2005

(30) Foreign Application Priority Data
Nov. 2, 2004 (JP) 2004-318894

(51) Int. Cl. G05F 1/10

(52) U.S. Cl. 327/543

(57) ABSTRACT

A semiconductor device having a current control circuit includes: a current source; a capacitor charged by the current output from the current source; a switch circuit for controlling charge and discharge of the capacitor; a voltage comparator for comparing the voltage of the charged capacitor with a reference voltage; and a control circuit for creating a control signal based on a result of comparison, feeding back the control signal to the current source so that the voltage of the capacitor is made near to the reference voltage as well as controlling a reference current output to the outside by the control signal.

### CROSS REFERENCE TO RELATED APPLICATION

This application is based upon and claims the benefit of priority from the prior Japanese Patent Application No. 2004-318894, filed on Nov. 2, 2004; the eitire contents of which are incorporated herein by reference.

### BACKGROUND OF THE INVENTION

1. Field of the Invention

The present invention relates to a semiconductor device including a current control circuit of a reference current source.

2. Related Background Art

Heretofore, in a general analog circuit including a circuit such as a switched-capacitor circuit and the like for charging and discharging a capacitor, a reference current source for determining the operation current of the overall circuit is designed to have a constant current value. In this case, the settling characteristics of the switched-capacitor circuit have such a factor that they are varied depending on the change of a clock cycle, the manufacturing dispersion of the capacitance value of a capacitor, the temperature/power supply voltage dependence of the reference current source, and the like. Accordingly, a problem arises in that a circuit margin must be set large by designing a reference current to a large value, and the like so that the settling characteristics satisfy a specification under all the conditions.

As a method of avoiding the problem, there is conventionally proposed a circuit for generating a reference current signal proportional to an absolute temperature, a capacitance, and a clock signal frequency by a feedback method using, for example, a clock signal as a reference (refer to, for example, page 10 and FIG. 5 of Japanese Patent Laid-Open Publication No. 2000-295047).

In this type of the circuit, however, since the stability of a system must be generally taken into consideration, the number of parameters such as the size of a transistor and the capacitance value of a capacitor to be selected, and the like, which must be taken into consideration in design, is increased, it is difficult to design a circuit to satisfy these parameters.

### SUMMARY OF THE INVENTION

According to one embodiment of the present invention, there is provided a semiconductor device having a current control circuit comprises: a current source; a capacitor charged by the current output from the current source; a switch circuit for controlling charge and discharge of the capacitor; a voltage comparator for comparing the voltage of the charged capacitor with a reference voltage; and a control circuit for creating a control signal based on a result of comparison, feeding back the control signal to the current source so that the voltage of the capacitor is made near to the reference voltage as well as controlling a reference current output to the outside by the control signal.

### BRIEF DESCRIPTION OF THE DRAWINGS

FIG. 1 is a block diagram showing a current control circuit of the embodiment 1 of the semiconductor device according to the present invention.

FIG. 2 is a signal waveform diagram showing the operation characteristics of a current control circuit of a first embodiment of a semiconductor device according to the present invention.

FIG. 3 is a block diagram showing a current control circuit of the embodiment 2 of the semiconductor device according to the present invention.

FIG. 4 is a block diagram showing a current control circuit of the embodiment 3 of the semiconductor device according to the present invention.

FIG. 5 is a block diagram showing a current control circuit of the embodiment 4 of the semiconductor device according to the present invention.

FIG. 6 is a block diagram showing a current control circuit of the embodiment 5 of the semiconductor device according to the present invention.

FIG. 7 is a block diagram showing a current control circuit of the embodiment 6 of the semiconductor device according to the present invention.

### DETAILED DESCRIPTION OF THE EMBODIMENTS

Embodiments of the present invention will be described below with reference to the drawings.

### Embodiment 1

A semiconductor device of this embodiment includes a current control circuit and a circuit to which a reference current is supplied from the current control circuit. The current control circuit will be described below in detail.

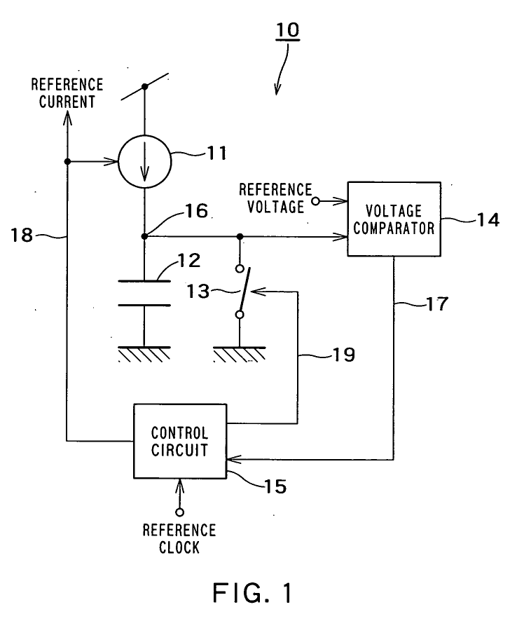

FIG. 1 is a block diagram showing a current control circuit of the embodiment 1 of the semiconductor device according to the present invention.

The current control circuit 10 has a current source 11, a capacitor 12 for accumulating a current from the current source 11, a switch circuit 13 for manipulating charge and discharge of the capacitor 12, a voltage comparator 14 for comparing the voltage of the capacitor 12 at a node 16 with the reference voltage from a reference voltage source (not shown) and outputting a result of comparison to a control circuit 15, and the control circuit 15 for controlling the current source 11 and the switch circuit 13. On receiving the output signal from the voltage comparator 14, the control circuit 15 outputs a switch control signal 19 to the switch circuit 13 at a timing according to the control cycle created by a reference clock and further outputs a current control signal 18 to the current source 11 and the circuits located externally of the current control circuit in the semiconductor device.

Next, operation of the current control circuit 10 will be explained. Since the capacitor 12 is completely discharged, it starts from a state of a zero charge. Further, the control circuit 15 turns off the switch circuit 13 during the period of a reference clock cycle T_{CLK}.

First, a current I1 is caused to flow to the current source 11. At the time, the capacitor 12 (capacitance value: C_{REF}) is charged with a voltage shown by the following expression (1).
V₁=I₁T_{CLK}/C_{REF} (1)

At the time, the voltage comparator 14 compares the voltage V₁ of the node 16 with the reference voltage V_{REF} and transmits a comparator output signal 17 as a result of determination of the magnitudes of them to the control circuit 15. When the voltage V₁ is larger than the reference voltage V_{REF}, the control circuit 15 changes the current value of the current source 11 to a current value I₂ smaller than the current value of the current source I₁ and sets the current value I₂. In contrast, when V₁ is smaller than VREF, the control circuit 15 changes the current value of the current source 11 to a current value I₂ larger than the current source I₁ and sets the current value I₂.

Subsequently, the control circuit 15 transmits a switch control signal 19 to turn on the switch circuit 13 during the period of a clock cycle T_{CLK} to be supplied next. The switch circuit 13 is turned on in response to the signal, and the charge accumulated in the capacitor 12 is discharged. Repetition of the above operation causes the voltage Vₙ charged in the capacitor 12 to be fed back to and finally converged to the reference voltage V_{REF}. At the time, the current Iₒ of the current source 11 is converged to satisfy the following expression (2).
C_{REF}·V_{REF}=Iₒ·T_{CLK} (2)

Here, the settling characteristics of the current control circuit is determined by the band of an amplifier to be used (unity gain frequency ω) and a slew rate Sr. Further, they are generally shown by the expressions (3) and (4) by the relation between a capacitor C, the bias current I of an amplifier, and the current gain gm of a transistor.
ω∝gm/C (3)
Sr∝I/C (4)

Here, the current gain gm is proportional to the bias current I or the root of the bias current I. Accordingly, when the relation between C_{REF}·V_{REF}=Iₒ T_{CLK} is constant, approximately constant settling characteristics can be satisfied.

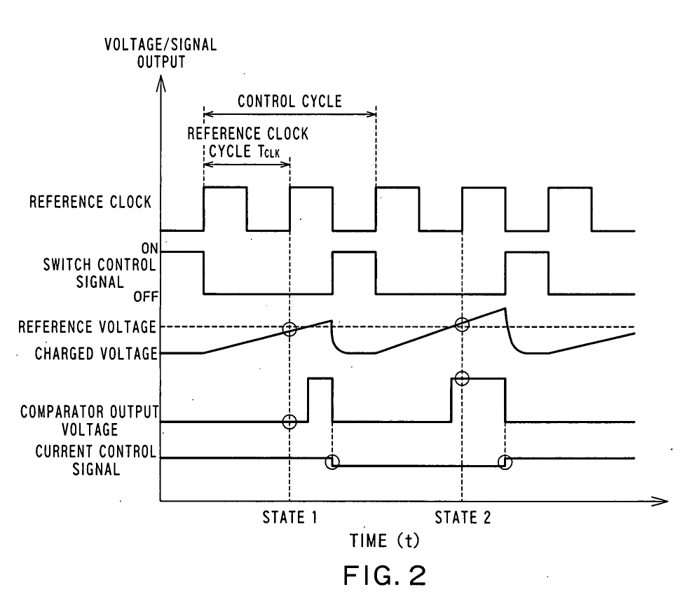

FIG. 2 shows the state, in which the feedback acts as described above, as signal waveforms. The control circuit 15 turns off the switch control signal at the rising edge of a reference clock. The capacitor 12 begins to be charged from this point.

First, the voltage charged to the capacitor 12 and the reference voltage are input to the voltage comparator 14, and the voltage comparator 14 determines which of them is larger, and outputs a result of determination. In a state 1, the reference voltage exceeds the charged voltage. In contrast, in a state 2, the charged voltage exceeds the reference voltage.

The control circuit 15 refers to the voltage output from the comparator at the next rising edge of the reference clock and controls the current control signal by increasing or decreasing it based on a result of comparison when the reference clock falls next. Further, at the same time, the control circuit 15 turns on the switch control signal to discharge the capacitor 12.

As described above, the settling characteristics of the switched-capacitor circuit can be kept approximately constant at all times using the reference current created by the current control circuit shown in the embodiment by causing the feedback mechanism to operate with reference to the reference voltage and the reference clock. Accordingly, the dispersion of the settling characteristics can be estimated small, thereby a circuit margin can be designed to a small value.

### Embodiment 2

A semiconductor device of this embodiment includes a current control circuit and a circuit to which a reference current is supplied from the current control circuit. The current control circuit will be described below in detail.

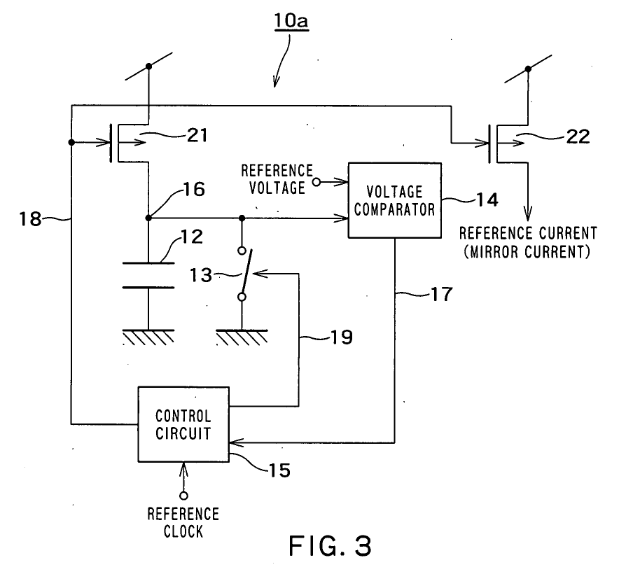

FIG. 3 is a block diagram showing a current control circuit of the embodiment 2 of the semiconductor device according to the present invention. The current control circuit of this embodiment has substantially the same basic configuration as the current control circuit of the embodiment 1.

The embodiment 2 is different from the embodiment 1 in that it employs a MOS transistor as a current source.

The current control circuit 10a has a first MOS transistor 21 as a current source, a capacitor 12 for accumulating a current from the first MOS transistor 21, a switch circuit 13 for manipulating charge and discharge of the capacitor 12, a voltage comparator 14 for comparing the voltage of the capacitor 12 at a node 16 with the reference voltage from a reference voltage source (not shown) and outputting a result of comparison to a control circuit 15, a second MOS transistor 22 to which the same gate voltage as the first MOS transistor 21 is applied and which flows a mirror current as a reference current to the outside of the current control circuit 10a, and the control circuit 15 for controlling the first and second MOS transistors 21 and 22 and the switch circuit 13.

On receiving the output signal from the voltage comparator 14, the control circuit 15 outputs a switch control signal 19 to the switch circuit 13 at a timing according to the control cycle created by a reference clock and further outputs a current control signal 18 for controlling a reference current to be output to the circuits located externally of the current control circuit in a semiconductor device by applying a current control signal 18 to gates of the first and second MOS transistors 21 and 22.

Operation of the current control circuit 10a will be concisely explained because it is the same as the embodiment 1.

Since the capacitor 12 is completely discharged, it starts from a state of a zero charge. Further, the control circuit 15 turns off the switch circuit 13 during the period of a reference clock cycle T_{CLK}.

First, a current I₁ is caused to flow to the first MOS transistor 21. With this operation, the capacitor 12 is charged.

At the time, the voltage comparator 14 compares the voltage V₁ at the node 16 with the reference voltage VREF and transmits a comparator output signal 17 as a result of determination of magnitudes of them to the control circuit 15. When V₁ is larger than V_{REF}, the control circuit 15 changes the current value of the first MOS transistor 21 as the current source to a current value I₂ smaller than the current value I₁ and sets the current value I₂. In contrast, when V₁ is smaller than V_{REF}, the control circuit 15 changes the current value of the first MOS transistor 21 as the current source to a current value I₂ larger than I₁.

Subsequently, the control circuit 15 transmits a switch control signal 19 to turn on the switch circuit 13 during the period of a clock cycle T_{CLK} to be supplied next. The switch circuit 13 is turned on in response to the signal, and the charge accumulated in the capacitor 12 is discharged. Repetition of the above operation causes the voltage Vₙ charged in the capacitor 12 to be fed back to and finally converged to the reference voltage V_{REF}. At the time, the current of the first MOS transistor 21 is also converged.

Since the same signal as the current control signal applied to the gate of the first MOS transistor 21 is applied to the gate of the second MOS transistor 22, a mirror current of the first MOS transistor 21 flows in the second MOS transistor 22. The mirror current is output to the outside of the current control circuit 10a as the reference current.

As described above, the settling characteristics of the switched-capacitor circuit can be kept approximately constant at all times using the reference current created by the current control circuit shown in the embodiment by causing the feedback mechanism to operate with reference to the reference voltage and the reference clock. Accordingly, the dispersion of the settling characteristics can be estimated small, thereby a circuit margin can be designed to a small value.

### Embodiment 3

A semiconductor device of this embodiment includes a current control circuit and a circuit to which a reference current is supplied from the current control circuit. The current control circuit will be described below in detail.

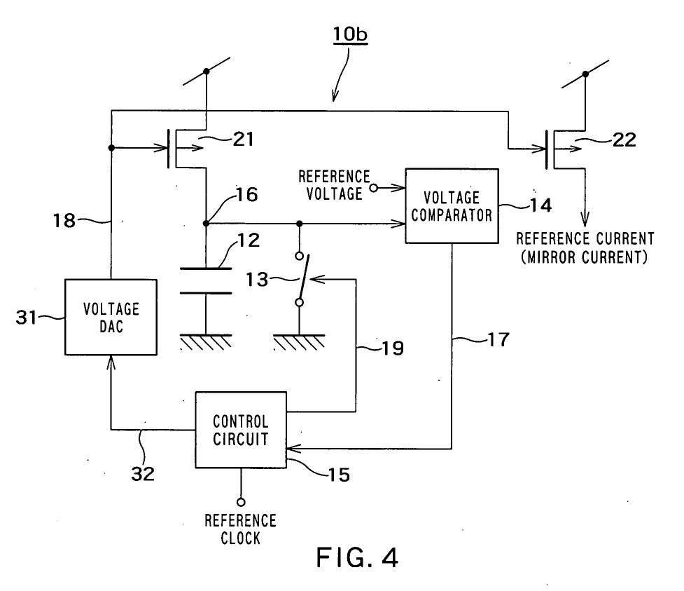

FIG. 4 is a block diagram showing a current control circuit of the embodiment 3 of the semiconductor device according to the present invention. The current control circuit of this embodiment has substantially the same basic configuration as the current control circuit of the embodiment 2.

The embodiment 3 is different from the embodiment 2 in that a voltage D/A converter is disposed behind a control circuit.

The current control circuit 10b has a first MOS transistor 21 as a current source, a capacitor 12 for accumulating a current from the first MOS transistor 21, a switch circuit 13 for manipulating charge and discharge of the capacitor 12, a voltage comparator 14 for comparing the voltage of the capacitor 12 at a node 16 with the reference voltage from a reference voltage source (not shown) and outputting a result of comparison to a control circuit 15, a second MOS transistor 22 to which the same gate voltage as the first MOS transistor 21 is applied and which flows a mirror current as a reference current to the outside of the current control circuit 10b, a voltage D/A converter 31 disposed behind the control circuit 15, and the control circuit 15 for controlling the first and second MOS transistors 21 and 22 and the switch circuit 13 via the voltage D/A converter 31.

On receiving the output signal from the voltage comparator 14, the control circuit 15 outputs a switch control signal 19 to the switch circuit 13 at a timing according to the control cycle created by a reference clock and further applies a digital control signal 32 to the voltage D/A converter 31. The voltage D/A converter 31 applies an analog control voltage signal 18 to gates of the first and second MOS transistors 21 and 22. A reference current is output from the second MOS transistor 22 to the circuits located externally of a current control circuit in a semiconductor device based on the analog control voltage signal 18.

Operation of the current control circuit 10b will be concisely explained because it is the same as the embodiment 1.

Since the capacitor 12 is completely discharged, it starts from a state of a zero charge. Further, the control circuit 15 turns off the switch circuit 13 during the period of a reference clock cycle T_{CLK}.

First, a current I₁ is caused to flow to the first MOS transistor 21. With this operation, the capacitor 12 is charged.

At the time, the voltage comparator 14 compares the voltage V₁ at the node 16 with the reference voltage V_{REF} and transmits a comparator output signal 17 as a result of determination of magnitudes of them to the control circuit 15. When V₁ is larger than V_{REF}, the control circuit 15 changes the current value of the first MOS transistor 21 as the current source to a current value I₂ smaller than the current value I₁ and sets the current value I₂. In contrast, when V₁ is smaller than V_{REF}, the control circuit 15 changes the current value of the first MOS transistor 21 as the current source to a current value I₂ larger than I₁. At the time, a control signal 32 output from the control circuit 15 is a digital signal, and the voltage DAC, which receives the control signal, applies the analog control voltage signal 18 to gates of the first and second MOS transistors 21 and 22.

Subsequently, the control circuit 15 transmits a switch control signal 19 to turn on the switch circuit 13 during the period of a clock cycle T_{CLK} to be supplied next. The switch circuit 13 is turned on in response to the signal, and the charge accumulated in the capacitor 12 is discharged. Repetition of the above operation causes the voltage Vₙ charged in the capacitor 12 to be fed back to and finally converged to the reference voltage V_{REF}. At the time, the current of the first MOS transistor 21 is also converged.

Since the same signal as the current control signal applied to the gate of the first MOS transistor 21 is applied to the gate of the second MOS transistor 22, a mirror current of the first MOS transistor 21 flows in the second MOS transistor 22. As described above, the settling characteristics of the switched-capacitor circuit can be kept approximately constant at all times using the reference current created by the current control circuit shown in the embodiment by causing the feedback mechanism to operate with reference to the reference voltage and the reference clock. Accordingly, the dispersion of the settling characteristics can be estimated small, thereby a circuit margin can be designed to a small value.

### Embodiment 4

A semiconductor device of this embodiment includes a current control circuit and a circuit to which a reference current is supplied from the current control circuit. The current control circuit will be described below in detail.

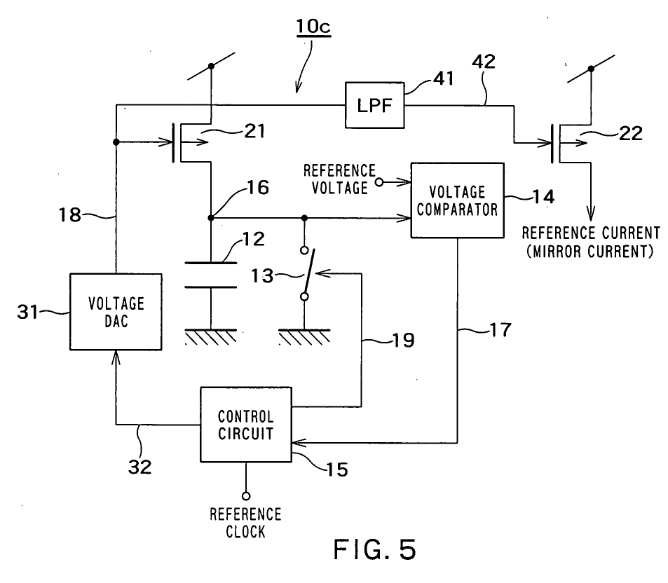

FIG. 5 is a block diagram showing a current control circuit of the embodiment 4 of the semiconductor device according to the present invention. The current control circuit of this embodiment has substantially the same basic configuration as the current control circuit of the embodiment 3.

The embodiment 4 is different from the embodiment 3 in that a low-pass filter 41 is interposed between the voltage DA converter 31 and the second MOS transistor 22 to suppress the harmonic component of a gate voltage.

The current control circuit 10c has a first MOS transistor 21 as a current source, a capacitor 12 for accumulating a current from the first MOS transistor 21, a switch circuit 13 for manipulating charge and discharge of the capacitor 12, a voltage comparator 14 for comparing the voltage of the capacitor 12 at a node 16 with the reference voltage from a reference voltage source (not shown) and outputting a result of comparison to a control circuit 15, a second MOS transistor 22 to which the same gate voltage as the first MOS transistor 21 is applied and which flows a mirror current as a reference current to the outside of the current control circuit 10c, a voltage D/A converter 31 disposed behind the control circuit 15, a low-pass filter 41 for suppressing a harmonic component of the voltage applied to a gate of the second MOS transistor 22, and the control circuit 15 for controlling the first and second MOS transistors 21 and 22 and the switch circuit 13 via the voltage D/A converter 31.

On receiving the output signal from the voltage comparator 14, the control circuit 15 outputs a switch control signal 19 to the switch circuit 13 at a timing according to the control cycle created by a reference clock and further applies a digital control signal 32 to the voltage D/A converter 31. The voltage D/A converter 31 applies an analog control voltage signal 18 to gates of the first and second MOS transistors 21 and 22. A reference current is output from the second MOS transistor 22 to the circuits located externally of a current control circuit in a semiconductor device based on an output MOS transistor control signal 42.

Operation of the current control circuit 10c will be concisely explained because it is the same as the embodiment 1.

Since the capacitor 12 is completely discharged, it starts from a state of a zero charge. Further, the control circuit 15 turns off the switch circuit 13 during the period of a reference clock cycle T_{CLK}.

First, a current I₁ is caused to flow to the first MOS transistor 21. With this operation, the capacitor 12 is charged.

At the time, the voltage comparator 14 compares the voltage V₁ at the node 16 with the reference voltage V_{REF} and transmits a comparator output signal 17 as a result of determination of magnitudes of them to the control circuit 15. When V₁ is larger than V_{REF}, the control circuit 15 changes the current value of the first MOS transistor 21 as the current source to a current value I₂ smaller than the current value I₁ and sets the current value I₂. In contrast, when V₁ is smaller than V_{REF}, the control circuit 15 changes the current value of the first MOS transistor 21 as the current source to a current value I₂ larger than I₁. At the time, a control signal 32 output from the control circuit 15 is a digital signal, and the voltage DAC, which receives the control signal, applies the analog control voltage signal 18 to the gate of the first MOS transistors 21 and, via the LPF (low-pass filter) 41, to the gate of the second MOS transistors 22.

Subsequently, the control circuit 15 transmits a switch control signal 19 to turn on the switch circuit 13 during the period of a clock cycle T_{CLK} to be supplied next. The switch circuit 13 is turned on in response to the signal, and the charge accumulated in the capacitor 12 is discharged. Repetition of the above operation causes the voltage Vₙ charged in the capacitor 12 to be fed back to and finally converged to the reference voltage V_{REF}. At the time, the current of the first MOS transistor 21 is also converged.

Since the same signal as the current control signal applied to the gate of the first MOS transistor 21 is applied to the gate of the second MOS transistor 22, a mirror current of the first MOS transistor 21 flows in the second MOS transistor 22. At the time, the noise (harmonic component in synchronism with a clock) of the analog signal supplied from the voltage DAC 31 is cut by connecting the LPF 41 to the gate of the second MOS transistor 22, thereby the noise of the second MOS transistor 22 can be suppressed.

As described above, the settling characteristics of the switched-capacitor circuit can be kept approximately constant at all times using the reference current created by the current control circuit shown in the embodiment by causing the feedback mechanism to operate with reference to the reference voltage and the reference clock. Accordingly, the dispersion of the settling characteristics can be estimated small, thereby a circuit margin can be designed to a small value.

Further, a harmonic component, which is in synchronism with the clock and is not intrinsically transmitted, can be eliminated by using the LPF.

### Embodiment 5

A semiconductor device of this embodiment includes a current control circuit and a circuit to which a reference current is supplied from the current control circuit. The current control circuit will be described below in detail.

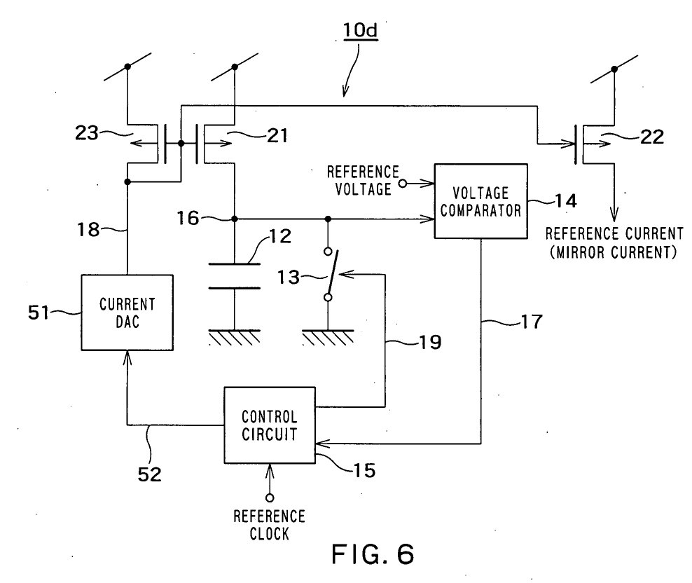

FIG. 6 is a block diagram showing a current control circuit of the embodiment 5 of the semiconductor device according to the present invention. The current control circuit of this embodiment has substantially the same basic configuration as the current control circuit of the embodiment 3.

The embodiment 5 is different from the embodiment 3 in that a current DAC 51 is disposed behind a control circuit in place of the voltage DAC, the current DA converter signal 52 from the control circuit 15 is converted into an analog signal, further a third MOS transistor 23 is disposed behind the current DAC 51, and the current output from the current DAC 51 is subjected to current/voltage conversion by a current mirror arrangement using the third MOS transistor 23 and applied to first and second MOS transistors 21 and 22.

The current control circuit 10d has a first MOS transistor 21 as a current source, a capacitor 12 for accumulating a current from the first MOS transistor 21, a switch circuit 13 for manipulating charge and discharge of the capacitor 12, a voltage comparator 14 for comparing the voltage of the capacitor 12 at a node 16 with the reference voltage from a reference voltage source (not shown) and outputting a result of comparison to a control circuit 15, a second MOS transistor 22 to which the same gate voltage as the first MOS transistor 21 is applied and which flows a mirror current as a reference current to the outside of the current control circuit 10d, a current D/A converter 51 disposed behind the control circuit 15, a third MOS transistor 23 which acts as a current to voltage conversion element constituting a current mirror by receiving the current output from the current DAC 51 and supplies a voltage to gates of the first and second MOS transistors 21 and 22, and the control circuit 15 for controlling the first and second MOS transistors 21 and 22 and the switch circuit 13 via the current DAC 51 and the third MOS transistor 23.

On receiving the output signal from the voltage comparator 14, the control circuit 15 outputs a switch control signal 19 to the switch circuit 13 at a timing according to the control cycle created by a reference clock and further applies a current D/A converter control signal 52 to the current D/A converter 51. The current control signal 18 as the analog signal from the current DAC 51 is subjected to current to voltage conversion by the third MOS transistor 23 and applied to gates of the first and second MOS transistors 21 and 22. A reference current is output from the second MOS transistor 22 to the circuits located externally of a current control circuit in a semiconductor device based on the current control signal 18.

The explanation of operation of the current control circuit 10d is omitted because it is approximately the same as the embodiments 1 to 4.

As described above, the settling characteristics of the switched-capacitor circuit can be kept approximately constant at all times using the reference current created by the current control circuit shown in the embodiment by causing the feedback mechanism to operate with reference to the reference voltage and the reference clock. Accordingly, the dispersion of the settling characteristics can be estimated small, thereby a circuit margin can be designed to a small value.

### Embodiment 6

A semiconductor device of this embodiment includes a current control circuit and a circuit to which a reference current is supplied from the current control circuit. The current control circuit will be described below in detail.

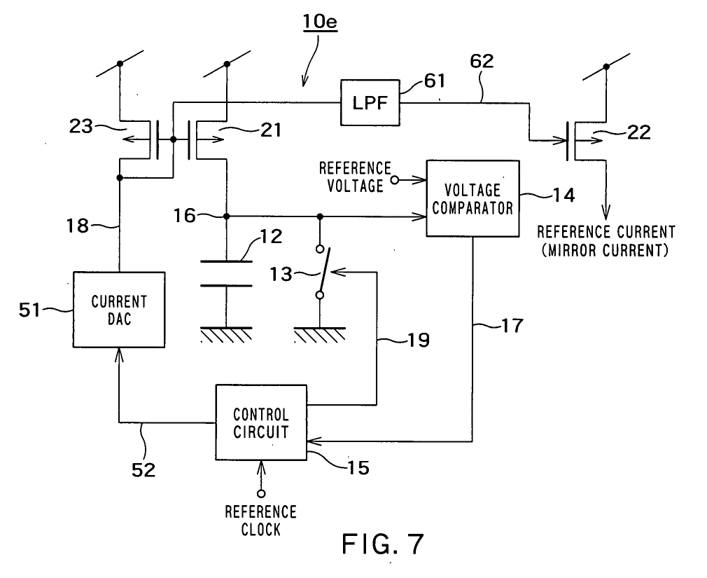

FIG. 7 is a block diagram showing a current control circuit of the embodiment 6 of the semiconductor device according to the present invention. The current control circuit 10e of this embodiment has substantially the same basic configuration as the current control circuit of the embodiment 5.

The embodiment 6 is different from the embodiment 5 in that an LPF 61 is interposed between a current DAC 51 and a second MOS transistor 22. That is, the analog signal output from the current DAC 51 is converted into a gate voltage by a third MOS transistor 23. The LPF 61 suppresses noise to the gate voltage.

Note that since the embodiment is fundamentally a combination of the embodiments 5 and 4, the detailed explanation thereof is omitted.

As described above, the settling characteristics of the switched-capacitor circuit can be kept approximately constant at all times using the reference current created by the current control circuit shown in the embodiment by causing the feedback mechanism to operate with reference to the reference voltage and the reference clock. Accordingly, the dispersion of the settling characteristics can be estimated small, thereby a circuit margin can be designed to a small value.

More specifically, according to the above-mentioned embodiments, in the circuit such as the switched-capacitor circuit and the like in which the capacitor is charged and discharged, the reference current value can be subjected to a feed-back control so that the settling characteristics are made constant according to the clock cycle regardless the manufacturing dispersion of the capacitance value of the capacitor using the current control circuit making use of the reference clock and the reference voltage.

Further, noise to the gate voltage can be suppressed using the LPF.

It should be noted that the present invention is by no means limited to the embodiments described above and can be variously modified within a scope which does not depart from the gist of the present invention.

A bipolar transistor may be used as the current source, instead of the MOS transistor.

Further, a MOS transistor and a bipolar transistor, for example, may be used to the switch circuit.

Furthermore, the present invention is the semiconductor device including the current control circuit exemplified by the embodiments described above, and it is needless to say that the other circuits included in the semiconductor device are various circuits such as a logic circuit, a memory circuit, and the like.

What is claimed is:

1. A semiconductor device having a current control circuit comprising:
a current source;
a capacitor charged by the current output from the current source;
a switch circuit for controlling charge and discharge of the capacitor;
a voltage comparator for comparing the voltage of the charged capacitor with a reference voltage; and
a control circuit for creating a control signal based on a result of comparison, feeding back the control signal to the current source so that the voltage of the capacitor is made near to the reference voltage as well as controlling a reference current output to the outside by the control signal.

2. The semiconductor device according to claim 1, wherein the current control circuit further includes a voltage DA converter disposed to the output side thereof.

3. The semiconductor device according to claim 1, wherein the current source is a first insulation gate type field effect transistor.

4. The semiconductor device according to claim 3, wherein the current control circuit further includes a voltage DA converter disposed to the output side thereof.

5. The semiconductor device according to claim 3, wherein the current control circuit further includes a second insulation gate type field effect transistor, the output side of the current control circuit is connected to gates of the first and second insulation gate type field effect transistors, and the reference current is output from the second insulation gate type field effect transistor to the outside of the current control circuit.

6. The semiconductor device according to claim 5, wherein the current control circuit further includes a voltage DA converter disposed to the output side thereof.

7. The semiconductor device according to claim 6, wherein the current control circuit further includes a low pass filter interposed between the voltage DA converter and the second insulation gate type field effect transistor.

8. The semiconductor device according to claim 1, wherein the current control circuit further includes a current DA converter connected to the output side of the current control circuit, and a first insulation gate type field effect transistor whose gate and drain are connected to the current DA converter.

9. The semiconductor device according to claim 3, wherein the current control circuit further includes a current DA converter connected to the output side of the current control circuit, and a second insulation gate type field effect transistor whose gate and drain are connected to the current DA converter.

10. The semiconductor device according to claim 5, wherein the current control circuit further includes a current DA converter connected to the output side of the current control circuit, and a third insulation gate type field effect transistor whose gate and drain are connected to the current DA converter.

11. The semiconductor device according to claim 10, wherein the current control circuit further includes a low pass filter interposed between the current DA converter and the second insulation gate type field effect transistor.
